(19) United States
(12) Patent Application Publication
(10) Pub. No.: US 2008/0067955 A1
(43) Pub. Date: Mar. 20, 2008

(54) Lighting controls and lighting appliances incorporating lighting controls

(76) Inventors: J. Vern Cunningham, Aurora (CA); Kevin Campbell, Woodbridge (CA)

Correspondence Address: Ralph A. Dowell of DOWELL & DOWELL P.C., 2111 Eisenhower Ave, Suite 406, Alexandria, VA, 22314, US

(21) Appl. No.: 11/523,093

(22) Filed: Sep. 19, 2006

(51) Int. Cl. H05B 37/02

(52) U.S. Cl. 315/307

(57) ABSTRACT

A lighting control for use with a lighting appliance includes a light sensor and a controller connected to the light sensor. Controller activates appliance when ambient light is greater than threshold. Threshold may be indicative of an interior of a closet of a room with a door of the closet open to the room and light available in the room. Controller may deactivate appliance once time has passed after appliance powered on. Lighting combination for use with power supply includes appliance including lighting source and control. Lighting control controls activation of lighting source. Controller has integrated memory for program to control controller. Controller may check to determine if light samples are increasing before activating lighting source. Start timer after light turned on. Turn off light when time out. Threshold learn mode based on sensed light before light on.

### FIELD OF THE INVENTION

The invention relates to lighting controls and lighting appliances in combination with lighting controls, and methods of operating lighting controls.

### BACKGROUND

There are many different applications for lighting appliances and lighting controls. In retrofit applications it is known to have battery operated lighting appliances to avoid rewiring. It is also known to have such lights turn on by motion sensors. It is also known to have such lights time out when a period of time has passed. Further alternative automated lighting controls and lighting appliances are desirable.

### SUMMARY

In a first aspect the invention provides a lighting control for use with a lighting appliance. The lighting control includes a light sensor and a controller connected to the light sensor. The controller is adapted to activate the appliance when ambient light incident on the light sensor is greater than a threshold stored in the controller.

The controller may be adapted to activate the appliance when ambient light incident on the sensor is greater than a threshold amount indicative of an interior of a closet of a room with a door of the closet open to the room and light available in the room.

The threshold may be greater than a value indicative of the ambient conditions when a user is not intending to use an area in which the appliance is located. The threshold may be lower than a value indicative of sufficient ambient light in the closet for a person to work by. The threshold may be lower than a value indicative of sufficient ambient light in an area in which the appliance is located for a person to work by.

The controller may be adapted to deactivate the lighting appliance once a given amount of time has passed since the lighting appliance was powered on.

In a second aspect the invention provides a lighting combination for use in association with a power supply. The lighting combination includes a lighting appliance including a lighting source powered by the power supply, and the lighting control of the first aspect. The lighting control is adapted to control activation of the lighting source.

The lighting control may be adapted to be connected between the power supply and the lighting source, and the lighting control may be adapted to control activation of the lighting source by controlling the application of power to the lighting source through the lighting control.

The lighting control may be adapted to be connected to the power supply, and the lighting control may be adapted to control activation of the lighting source by controlling the power supply to provide power to the lighting source.

The lighting control may be adapted to be connected to the lighting source, and the lighting control may be adapted to control activation of the lighting source by controlling the power drawn by the lighting source from the power supply.

The power supply may provide a DC supply of power, and the lighting control and lighting source may be adapted to operate from DC power. The lighting appliance may include the power supply and the power supply may include a DC battery power source. The battery power source may be a non-rechargeable dry cell battery.

The lighting appliance may include a power supply that is adapted to be connected to a power source external to the appliance for supply of power to the power supply. The external power source may be a non-rechargeable dry cell battery. The external power source may be an AC line source.

The lighting appliance may include the lighting control. The lighting appliance may include a housing and the lighting control, the lighting source, and at least a portion of the power supply may be housed by the housing. Alternatively, the power supply may be housed by the housing.

The lighting source may include a series of light emitting diodes.

The controller may include a processor and associated memory for control of the controller. The controller may be in the form of an integrated microcontroller that includes the processor and associated memory.

The light sensor may be a light dependent voltage divider. The divider may include a light dependent resistor, the resistance of which varies according to the amount of light incident upon by the resistor. The voltage divider may be adapted to output a voltage signal that varies as the light incident upon the light dependent resistor varies. The voltage divider may be connected to the controller and the voltage signal may be an input to the controller. The control may sample ambient light at the light sensor by having the controller read the signal input from the light sensor.

The power supply may include a plurality of dry cell batteries and a voltage regulator, and the plurality of dry cell batteries may include a first terminal and a second terminal, the first terminal may be connected to the lighting source and the second terminal may be connected to a voltage regulator to provide a regulated power supply to drive the control.

The controller may include an output and the lighting source may be connected between the output of the controller and the first terminal of the battery such that the control can control power to the lighting source. The output may be a current sink output.

The controller may have integrated memory for storage of a program to control operation of the controller. The memory may be programmed through an in system programming and serial programmable interface. The controller may have a RESET input, and activation of the RESET input may cause the controller to restart the program. The RESET input may be connected to a user-accessible switch external to the controller for activating the RESET input.

The program may include instructions to control the controller to control activation of the lighting source. The instructions may include instructions to the controller to sample ambient light repeatedly at the light sensor, to check the samples to determine if the ambient light samples are greater than a threshold, represented by a value stored in memory, and if so, to activate the lighting source.

The instructions may further include instructions to the controller to check, after determining that the ambient light samples are greater than the threshold, to determine if the light samples are increasing in value over time, and if so, only then to activate the lighting source. The controller may be adapted to activate the lighting source by sinking current at an output of the controller such that current is drawn through the lighting source from the power supply.

The instructions may further include instructions to the controller to start an internal timer. The instructions may further include instructions to call light off instructions.

The instructions may further include instructions to the controller to repeat repeatedly sampling and the instructions following repeatedly sampling if ambient light was not above the threshold or ambient light was not increasing.

The instructions may further include instructions to the controller to determine if the timer has timed out, and if not, to repeat determining if the timer has timed out and the instructions that follow. The instructions may further include instructions to the controller to repeat the sampling light repeatedly instruction and the instructions that follow.

The controller may be adapted to determine the threshold based on the actual level of ambient light ordinarily available at the light sensor immediately before a user would want the lighting source to be activated. The controller may be adapted to determine the threshold based on the level of ambient light in a closet when the closet door is closed.

The instructions may further include instructions to the controller to sample ambient light repeatedly, to average the ambient light samples, and to store in memory the average ambient light sample value. The controller may be adapted to ensure the lighting source is deactivated before sampling to determine a threshold starts. The instructions may further include instructions to the controller to delay to allow ambient light to reach a desired level before sampling to determine a threshold starts. The instructions may further include instructions to the controller to sample ambient light, and to store in memory a light sample value as the threshold.

The controller may be adapted to ensure the lighting source is deactivated before sampling to determine a threshold starts. The instructions may further include instructions to delay to allow ambient light to reach a desired level before sampling to determine a threshold starts.

The control may include a switch for manually powering the lighting source off. The lighting appliance may be a lighting fixture with a mounting for fixing the lighting fixture to an external support.

In another aspect the invention provides a method of operating a lighting control including a light sensor and a controller for use in association with a lighting appliance. The method includes the light sensor sensing ambient light incident upon the light sensor, and the controller activating the appliance when the sensed ambient light is greater than a threshold stored in the controller.

The threshold amount may be indicative of an interior of a closet of a room with a door of the closet open to the room and light available in the room. The threshold may be greater than a value indicative of the ambient light when a user is not intending to use an area in which the appliance is located. The threshold may be lower than a value indicative of sufficient ambient light in the closet for a person to work by. The threshold may be lower than a value indicative of sufficient ambient light in an area in which the appliance is located for a person to work by.

The controller may deactivate the lighting appliance once a given amount of time has passed since the lighting appliance was powered on. The lighting control may control activation of the lighting source by controlling the application of power to the lighting source through the lighting control. The lighting control may control activation of the lighting source by controlling the power supply to provide power to the lighting source. The lighting control may control activation of the lighting source by controlling the power drawn by the lighting source from the power supply. The power supply may provide a DC supply of power, and the lighting control and lighting source may operate from DC power.

The controller may sample ambient light repeatedly at the light sensor, check the samples to determine if the ambient light samples are greater than the threshold, represented by the value stored in memory, and if so, activate the lighting source.

The controller may check, after determining that the ambient light samples are greater than the threshold, to determine if the light samples are increasing in value over time, and if so, only then activates the lighting source. The controller may activate the lighting source by sinking current at an output of the controller such that current is drawn through the lighting source from a power supply. The controller may start an internal timer after activating the lighting source.

The controller may repeat repeatedly sampling and the steps of the method following repeatedly sampling if ambient light was not above the threshold or ambient light was not increasing. The controller may determine if the timer has timed out, and if not, repeat determining if the timer has timed out and the steps of the method that follow.

After the timer has timed out the controller may repeat sampling light repeatedly and the steps of the method that follow. Before the control unit senses ambient light to determine if the sensed ambient light is greater than the threshold, the controller may determine the threshold based on the actual level of ambient light ordinarily available at the light sensor immediately before a user would want the lighting source to be activated.

The control unit may sense ambient light to determine if the sensed ambient light is greater than the threshold, the controller may determine the threshold based on the level of ambient light in the closet when the closet door is closed.

Before the control unit senses ambient light to determine if the sensed ambient light is greater than the threshold, the controller may sample ambient light repeatedly, average the ambient light samples, and store in memory the average ambient light sample value as the threshold.

The controller may ensure the lighting source is deactivated before sampling to determine a threshold starts. The controller may delay to allow ambient light to reach a desired level before sampling to determine a threshold starts.

The controller may sample ambient light, and store in memory a light sample value as the threshold.

Other aspects of the invention will be evident from the detailed description, claims, and drawings herein.

### BRIEF DESCRIPTION OF THE DRAWINGS

For a better understanding of the present invention and to show more clearly how it may be carried into effect, reference will now be made, by way of example, to the accompanying drawings that show preferred embodiments of the present invention and in which:

FIG. 1 is a block diagram of a lighting control in accordance with an embodiment of an aspect of the present invention;

FIG. 2 is a block diagram of a lighting appliance incorporating the control of FIG. 1;

FIG. 3 is a schematic diagram of a lighting control in accordance with an embodiment of an aspect of the present invention;

FIG. 4 is a schematic diagram of an alternative lighting control in accordance with an embodiment of an aspect of the present invention;

FIG. 5 is a flow diagram of a light on method in accordance with an embodiment of an aspect of the present invention;

FIG. 6 is a flow diagram of a light off method in accordance with an embodiment of an aspect of the present invention;

FIG. 7 is a flow diagram of a learn mode method in accordance with an embodiment of an aspect of the present invention; and

FIG. 8 is a flow diagram of a lighting control method incorporating the methods of FIGS. 5-7.

### DETAILED DESCRIPTION

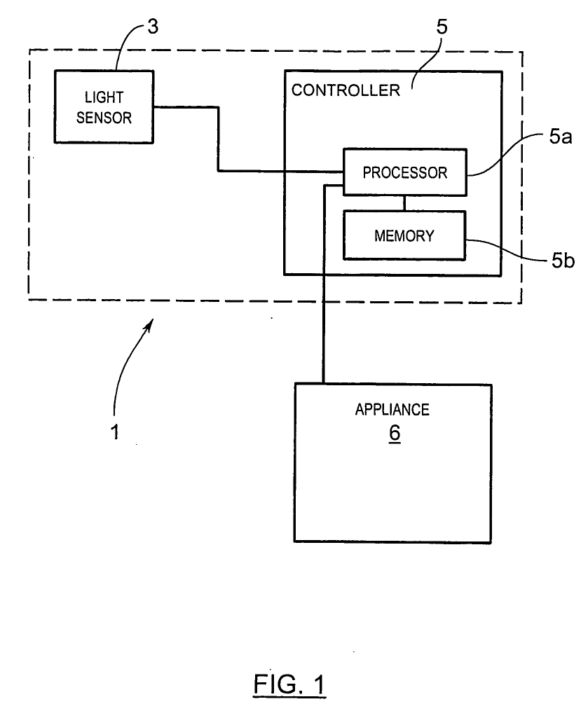

Referring to FIG. 1, a lighting control 1 has a light sensor 3 connected to a controller 5. The control 1 is adapted to activate an appliance 6 when ambient light is greater than a threshold. For example, the lighting control 1 and a lighting appliance 6 as the appliance 6 can be located in a closet of a room to provide additional working light. The lighting control 1 may be adapted to turn on the appliance 6 when ambient light is greater than a threshold amount indicative of an interior of the closet with a door of the closet open to the room and light available in the room. Typically, a room having a closet will be illuminated by daylight or artificial light when a person is using the closet. The control 1 may be adapted to turn the lighting appliance 6 off once a given amount of time has passed since the light appliance 6 was powered on. Although the threshold is greater than a value representative of the ambient light with a closet door open, or, more generally, a level indicative of the ambient conditions when a user is not intending to use an area in which the appliance 6 is located, the threshold will typically be lower than a value indicative of sufficient ambient light in a closet or, more generally, an area in which the appliance is located, than a person would desire to work by.

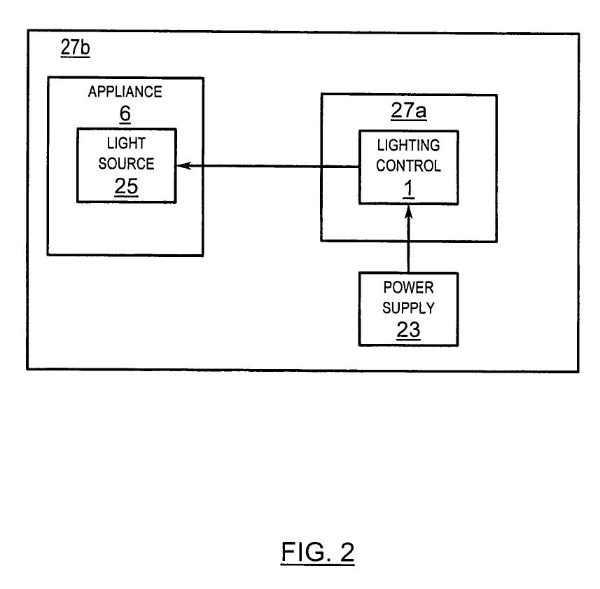

Referring to FIG. 2, a lighting appliance 6 has a lighting source 25. The control 1 is connected between a power supply 23 and the lighting source 25. Alternatively, the control 1 may be connected only to the power supply 23 and control the output of the power supply 23 to the lighting source 25, or may be connected only to the lighting source 25 and control the draw of the lighting source 25 from the power supply 23.

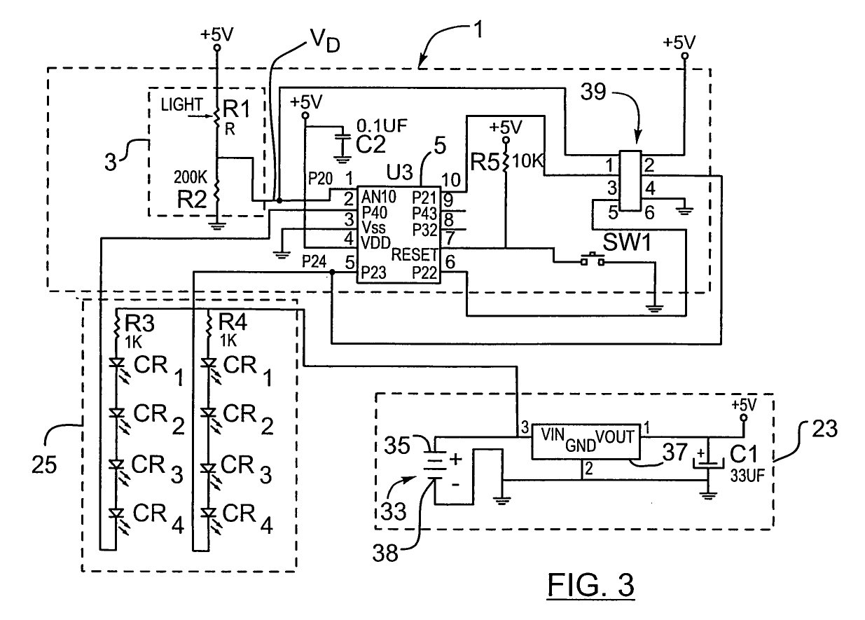

The power supply 23 may include a power source such as a DC battery 33 (see FIG. 3) that is rechargeable or non-rechargeable. Most likely a non-rechargeable dry cell battery 24 will be preferred for long-term lighting applications. Alternatively, the power supply 23 may be a DC source external to the lighting appliance 6 or an AC line source, not shown, external to the lighting appliance 6, in which case the power supply 23 may have external wiring to a power source from the lighting appliance 6. Battery operated lighting appliances 6 are particularly well suited to retrofit applications as no wiring to AC line power sources is required.

The control 1 may be part of the lighting appliance 6 or separate from, and connected to, the lighting appliance 6. For example, the control 1 may be contained within its own housing 27a and connected to an AC line source at an outlet receptacle. The lighting appliance 6 may also be connected to the control 1 such that the control 1 can control power from the power supply 23 to the lighting source 25 within the lighting appliance 6.

Referring to FIG. 3, the lighting source 25 may be a series of light emitting diodes (“LEDs”) CR1-CR4 or another lighting source, such as a fluorescent or filament lighting source. For low-power applications, such as those running from a battery, LEDs may be preferable as the lighting source 25. LEDs have other properties that may be advantageous, including low heat generation and high durability. Resistors R3 and R4 provide overcurrent protection to the LEDs CR1-CR4.

The controller 5 as shown in the FIGS. has a processor 5a and associated memory 5b in the form of a microcontroller. In FIG. 3 the controller 5 has been depicted based on a NEC Corporation uPD78F900™ series microcontroller. Alternatively, many other available microcontrollers may be utilized for the controller 5. Preferably, the controller 5 has low power consumption for use with a battery power supply 23. As the functions described herein for the controller 5 are not computationally intensive many available microcontrollers will be suitable. Alternatively, the controller 5 may utilize a processor 5a and separate memory 5b for storage. As a further alternative, the logic functions of the controller 5 may be implemented using discrete components, such as independently packaged transistors, resistors, capacitors and the like, or a combination of discrete components and multiple integrated circuits, such as timer integrated circuits, or any desired combination of discrete components and complex integrated circuits.

Light sensor 3 may be implemented as a light dependent voltage divider 3 incorporating a light dependent resistor (“LDR”) R1, the resistance of which varies according to the amount of light incident upon the resistor, in series with a resistor R2 between supply voltage +5V and ground. The voltage divider 3 outputs a voltage signal V_{D} that varies as the light input to the LDR R1 varies. The voltage divider 3 is connected to the controller 5 and the signal V_{D} is an input to the controller 5. The control 1 samples ambient light at the light sensor 3 by having the controller 5 read the signal V_{D} input from the light sensor 3.

The power supply 23 in the embodiment of the control 1 shown in FIG. 3 is a battery 33, for example five “AA” dry cells, having a positive terminal 35 that is connected to lighting source 25 and a negative terminal 36 connected to ground. It is recognized that ground is not an earth ground, but rather a reference voltage from which other voltages are measured. The positive and negative terminals of the battery could be exchanged with corresponding changes to the lighting source 25 and control 1 components. The battery 33 is also connected to a voltage regulator 37 such as a 78L05 to provide a regulated supply voltage +5V to drive the control 1. Of course, other voltage levels may be used as appropriate to drive the control for the particular design chosen for the control 1. A capacitor C1 is provided in the power supply to further smooth the output +5V of the regulator 37.

The voltage to the lighting source 25 from the power supply 23 could also be regulated; however, it may not be necessary provided that the battery voltage is within the operating range of the lighting source 25. In the embodiment shown in FIG. 3 the lighting source 25 has two branches of four LEDs in series with a 1 k-ohm protection resistor R3, R4. The LEDs can be higher power LEDs such that for example each LED branch can operate at approximately 7.5 volts from a regulated DC source or six dry cell batteries with a nominal voltage of 1.2V each. The LEDs as shown are higher power LEDs that put out a greater light output than traditional low power LEDs. Again, the lighting source 25 may have a different number or type of LEDs or may have a different type of lighting source altogether, depending on the desired characteristics of the lighting source 25.

A second terminal 38 of the battery 33 is connected to ground. The controller 5 is connected to ground at V_{SS} and to the supply voltage +5V at V_{DD} to power the controller 5. The controller 5 has two current sink outputs P23 and P40. Output P23 is connected to one branch of the lighting source 25, while the other output P40 is connected to the other branch of the lighting source 25. The controller 5 either allows the outputs P23, P40 to go to ground or to float. When grounded the outputs P23, P40 draw current through the lighting source 25 which is connected between the outputs P23, P40 and the positive battery terminal 35. The outputs P23, P40 may be independently controlled for different light output from the branches; however, this is not a requirement of the implementation described herein. Also less or more branches of LEDs may be used. By using multiple branches of LEDs one can use the full output capacity of the controller 5. Also, if one branch should become damaged then the other branch will continue to output light.

Connections to the battery terminals 35, 38 may be provided by way of a battery holder, not shown, with opposing contacts to engage the respective terminals 35, 38 to allow for manual removal and insertion of the batteries 33.

The controller 5 has integrated memory for storage of a program to control operation of the controller. The memory 5b may be programmed through an in system programming and serial programmable interface 39. The interface 39 may for example be a CON6A connected as shown for programming a uPD78F900. Alternate connection schemes and interfaces 39 can be used as required for programming the controller 5.

The controller 5 has a RESET input. Activation of the RESET input can cause the controller 5 to restart the program. Alternatively, as discussed later below, the RESET input can set an interrupt for the controller 5 from which the controller can be instructed by the program to start alternative instruction from a main program. As shown in FIG. 3, the RESET input can be connected to a switch SW1 external to the controller 5 for activating the RESET input. The switch SW1 can, for example, be a manual push button switch SW1 accessible to a user external to the lighting control 1 and the lighting appliance 6.

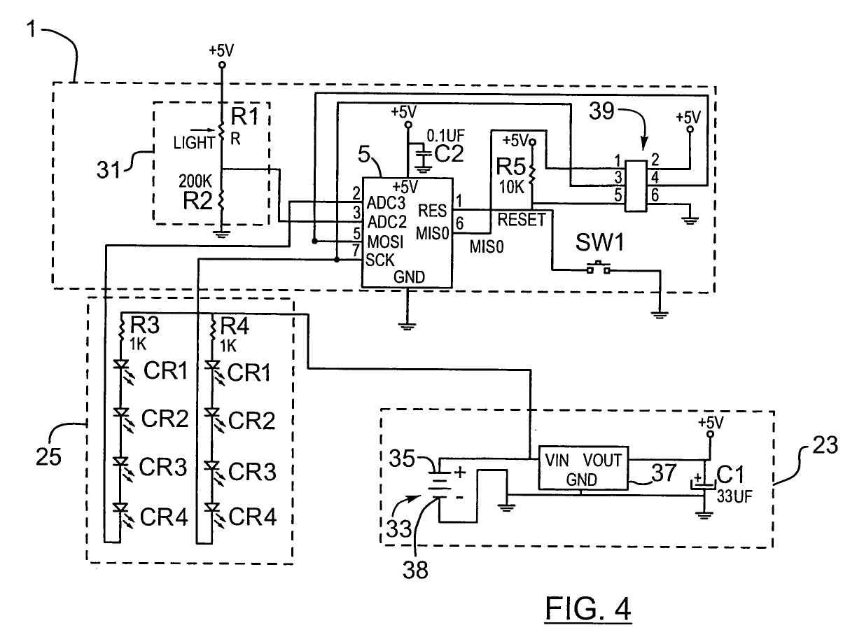

Referring to FIG. 4, an alternative version of the controller 5 based on an Atmel Corporation ATtiny13™ is shown. This requires some modifications to the pinouts of the controller 5; however, the structure and operation are generally the same.

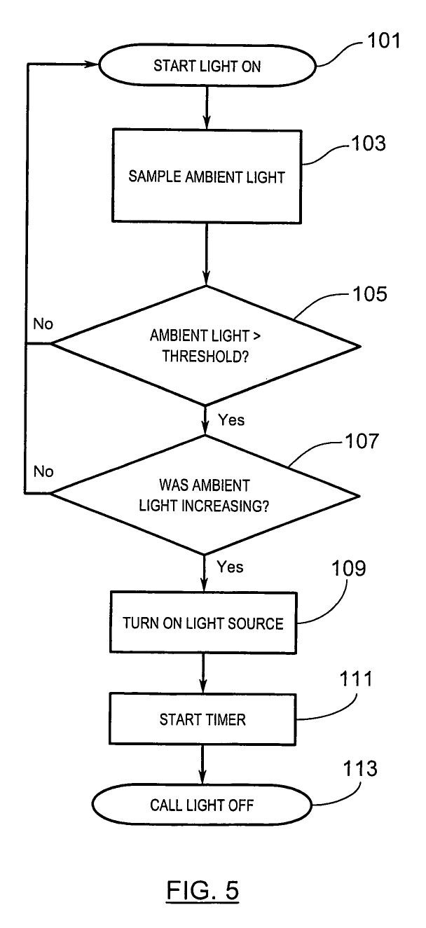

Referring to FIG. 5, an example method by which the lighting control 1 operates to control activation of the lighting source 25 is shown in flow chart form. The method can be implemented in the form of instructions in a computer program stored in memory 5b of the controller 5 to instruct the controller 5 to operate in accordance with the steps in the flow chart.

At 101 the method and instruction to turn the lighting source 25 on starts. At 103 the controller 5 is instructed to sample ambient light repeatedly at the light sensor 3 by periodically reading the V_{D} input and storing the samples in memory 5b. The stored samples can be overwritten when a new activation (light on) cycle commences. At 105 the controller 5 is instructed to check the samples to determine if the ambient light samples are greater than a light threshold, represented by a value stored in memory 5b. If so, at 107 the controller 5 is instructed to check to determine if the light samples are increasing in value over time. If so, at 109 the controller 5 is instructed to turn on the lighting source 25 by sinking current at the outputs P23 and P40 such that current is drawn through the lighting source 5 from the power supply 23. At 111 the controller 5 is instructed to start an internal timer and at 113 the controller 5 is instructed to call a light off method and instruction.

In one embodiment ten microsecond samples are taken twenty times over a ten millisecond period. If three consecutive samples are over the threshold and there is an increase in the sample values over the three samples then the lighting source 5 is activated. This is an example embodiment. Other embodiments can utilize alternative settings.

If at 105 ambient light was not above threshold or at 107 ambient light was not increasing then the controller 5 is instructed to start the light on method and instruction again at 101.

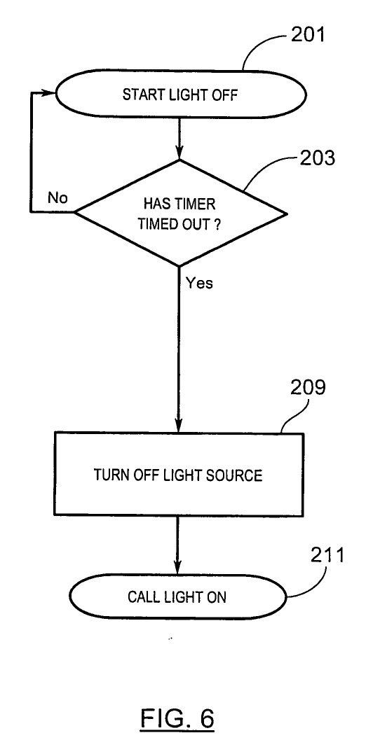

Referring to FIG. 6, an example method by which the lighting control 1 operates to turn off the lighting source 25 is shown in flow chart form. Again, the method can be implemented in the form of instructions in a computer program stored in memory of the controller 5 to instruct the controller 5 to operate in accordance with the steps in the flow chart.

At 201 the method and instruction to turn the lighting source 25 off starts. At 203 the controller 5 is instructed to determine if the controller 5 timer set by the light on program instructions of FIG. 3 has timed out. If not, the method and instruction to turn the lighting source 25 off starts again at 201. If the timer has timed out at 203 then the controller 5 is instructed to turn off the lighting source 25 at 209 as described previously and continues from there.

By using a timer to instruct the controller 5 to turn off the lighting source 25, battery power can be conserved as a user need not remember to turn off the lighting source 25. This is particularly advantageous as the lighting source 25 was automatically activated; so, the user did not participate in turning the lighting source 25 on and is unlikely to remember to turn the lighting source 25 off. Also, the lighting source 25 is not left on indefinitely in the event the lighting control 1 was triggered inadvertently, for example by a certain set of changes in ambient light that mimicked, but did not result from the closet door being opened by a user desiring to look in the closet. For example, a cat may have opened the closet door. Further, using a timer avoids the use of other manual user input devices, such as a switch similar to switch SW1. Such switch can be relatively expensive, and may be prone to breakdown. Also, fully automatic on/off control allows the lighting control 1 and the lighting appliance 6 to be placed in a location that might otherwise be difficult to access on a regular basis, for example, above a doorway or on a ceiling. As an example, the timer could be set to time for 2 minutes; however, lesser or greater times could be used.

Where the controller 5 is determining if light is increasing before activating the lighting source 25 and a user wishes the lighting appliance 6 to turn on again then light incident on the light sensor 3 can be reduced and increased such that the lighting source 25 will be activated. This can be accomplished in a closet application by closing and opening the closet door.

If determination of increasing light is not used then the lighting source 25 will be reactivated after time out. The controller 5 may include instructions not to reactivate unless the output V_{D} of the lighting sensor 3 is below the threshold before being above the threshold. Again, this can be accomplished in a closet application by closing and opening the closet door.

The controller 5 can include instructions, based on a limit stored in memory 5b, to limit the number of activations of the lighting source 25 in a given time period, for example, three times per hour. This can assist in reducing the possibility of false activations. False activations can affect battery life.

The threshold for use in the method and instruction of FIG. 3 may be determined based on the actual level of ambient light ordinarily available at the light sensor 3 immediately before a user would want the lighting source 25 to turn on. As an example, the control 1 and lighting appliance 6 can be particularly useful in closet lighting applications, and the threshold can be set based on the level of ambient light in the closet when the closet is closed. The threshold can then be used by the control 1 to turn on the lighting source 25 when the closet is opened. When the closet door is opened a user would want additional light to be able to see what is inside the closet.

As an alternative, the threshold can be preset based on a level of light above which one would not expect to see in a closet with a door shut. This would allow for a simple lighting control 1 with no user inputs such as switch SW1. However, such a simple lighting control 1 would not allow for configuration to the particular ambient light conditions for a given installation.

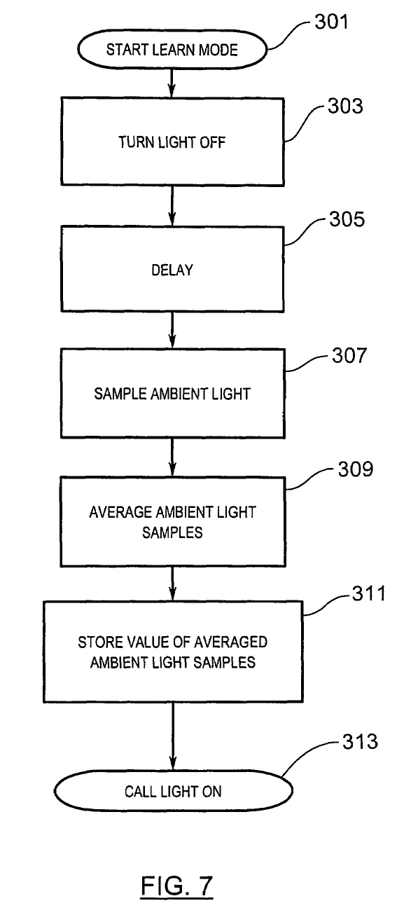

Referring to FIG. 7, an example method by which the lighting control 1 operates to determine the threshold is shown in flow chart form. Again, the method can be implemented in the form of instructions in a computer program stored in memory 5b of the controller 5 to instruct the controller 5 to operate in accordance with the steps in the flow chart.

At 301 the method and instruction for the controller 5 to enter threshold learn mode starts. At 303 the controller 5 is instructed to turn the lighting source 25 off as described previously in case the lighting source 25 is on. At 305 the controller 5 is instructed to delay to allow ambient light to reach a desired level. For example, if a closet needs to be closed then the delay allows a user time to close the closet. As an example, the delay could be thirty seconds.

At 307 the controller 5 is instructed to sample ambient light repeatedly after the delay. At 309 the controller is instructed to average the ambient light samples. At 311 an average ambient light sample value is stored in memory 5b of the controller 5. At 313 the controller 5 is instructed to call the light on method and instruction, for example at 101 of FIG. 3.

The ambient light is sampled repeatedly and average in an attempt to incorrect stored values based on spurious readings. A method and instruction could use a single sample. If operation appears to be affected adversely by a poor sample whether or not the sample is taken multiple times and averaged then a user can simply have the controller 5 enter the learn mode again to acquire a better sample. Sampling could occur, for example, using ten microsecond samples twenty times over a period of ten milliseconds. The samples could be added together and divided by twenty to average the samples. Again, this is an example embodiment. Other embodiments can utilize alternative settings.

During determination of the threshold the controller 5 can be instructed repeatedly to activate and deactivate (flash) the lighting source 25 to indicate the appliance 6 is capturing the threshold. The lighting source 25 is not activated by the controller 5 while a sample is being taken.

The stored value can be subject to additional processing such that it is increased by a desired amount, for example 5%, to create a higher threshold such that minor variations in lighting conditions will not trigger activation of the lighting source. The use of a higher threshold than the actual sensed ambient low light is optional. It is possible that an increase in the threshold may be disadvantageous for certain installations where ambient light changes very little between the low-light condition and the amount of ambient light where a user would desire the light to be activated. It is to be remembered that the light sensor may be in a position well away from external triggering lighting sources.

Based on the above example, the light would be turned on if the ambient light exceeds the threshold and is increasing. A set of samples should be taken sufficiently often and the samples in a set should be taken sufficiently far apart in time to be able to acquire samples showing increasing ambient light levels, for example, as a closet is opened.

The sensing of increasing ambient light levels is also optional. Samples of ambient light over the threshold can be used alone; however, increasing ambient light samples can be advantageous to avoid reduce false trigger that might drain battery life. For example, if a closet door is left open, but a user is not looking in the closet, for increased battery life, the lighting source 25 should not be turned on once it is off. The lighting source 25 will be activated when the door is opened and sufficient ambient light reaches the light sensor 3. After a given period of time the lighting source 25 will be deactivated. The lighting source 25 will not reactivate until the ambient light is over the threshold and increasing, for example when the closet door is shut and re-opened.

Also, the control circuit 1 could be provided with a switch, not shown, for manually powering the lighting source 25 on and off. The switch could be similar to the switch SW1.

The lighting source on method and instruction beginning at 101, the lighting source off method and instruction beginning at 201, and the learn mode method and instruction beginning at 301 have been shown as separate programs that might be implemented in different routines on the controller 5 with control moving back and forth within the controllers 5 between the routines, or there interoperation may be controlled by a higher task.

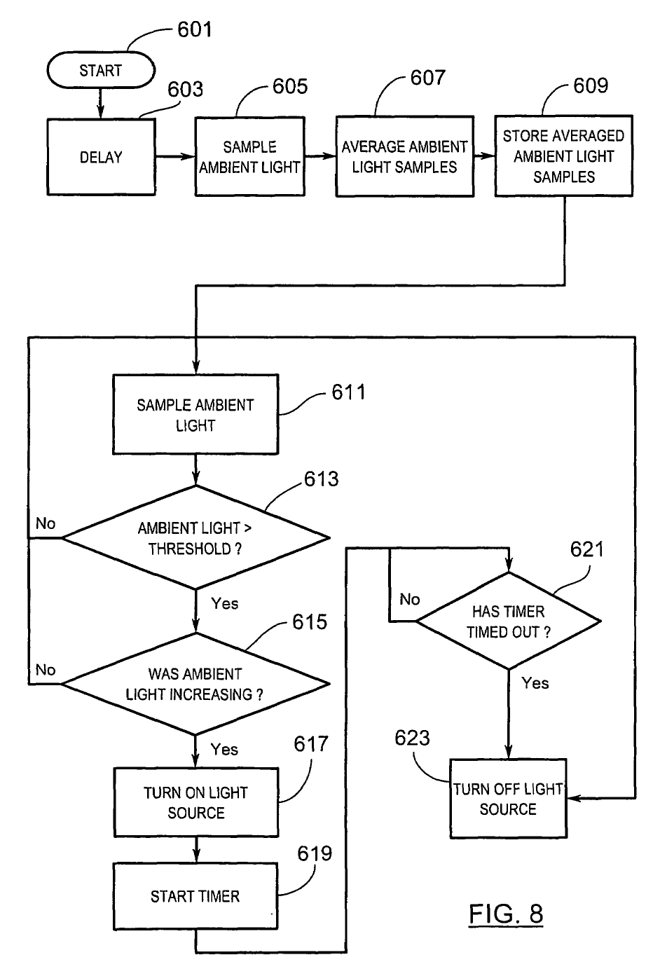

Referring to FIG. 8, an integrated method and instruction incorporating each of the methods and instructions describe above is shown. This is simple to implement in one of the example controllers 5 described previously. The method and instruction starts at 601. This would occur any time that the controller 5 is powered on or the switch SW1 is pressed to set the RESET input of the controller 5. The controller 5 is adapted to maintain the lighting source 25 deactivated when the controller 5 is first powered on or after the RESET input is set. In the example embodiment of the controller 5 described herein the controller 5 outputs are set as a default not to sink current when the controller 5 powers up.

First, after a delay at 603 the controller 5 commences to learn the threshold by sampling ambient light at 605. The samples are averaged at 607. A threshold is stored in memory based on the averaged ambient light samples at 609.

Second, the lighting source 25 is activated by the controller 5 after sampling the ambient light at 611 and comparing the sample to the threshold at 613. If the sample is not greater than the threshold then the controller 5 returns to sampling ambient light at 611 and continuing from there. If the sample is greater than the threshold then the controller 5 compares the sample to previous recent samples stored in memory to determine if the samples indicate increasing ambient light at 615. If the samples do not indicate increasing ambient light then the controller 5 returns to sampling ambient light at 611. If the samples do indicate increasing ambient light then the controller 5 activates the lighting source 25 at 617 and activates the timer at 619.

Third, the lighting source 25 is deactivated by the controller 5 by checking to see if the timer has timed out at 621. If the timer has timed out then the controller 5 deactivates the lighting source 25 at 623. If the timer has not timed out then the controller returns to checking if the timer has timed out at 621 and continues from there. Once the lighting source has been turned off at 623 then the controller 5 returns to sampling ambient light at 611 and activating the lighting source 25 as described above.

The method and instruction described commencing at 601 operates in a similar manner to the method and instruction described commencing at 101, 201 and 301.

The method and instruction of FIG. 8 is shown as a serial process for ease of understanding. It will be understood the method and instruction could operate as two or more processes initiated by, for example, interrupts. As an example, the threshold capture steps could run as a separate process initiated by an interrupt activated by a manual switch such as switch SW1. Once the threshold capture steps are complete then control can be returned to a main process executing the remaining process steps for activating and deactivating the lighting source 25. If the threshold is stored in non-volatile memory of memory 5b then the threshold can be retained when the battery 33 is replaced, such that threshold capture is not automatically required when the control 1 restarts.

The control 1 may be implemented on a printed circuit board, not shown, and mounted within the lighting appliance 6 or a separate housing 27a.

It is to be recognized that many different configurations of the lighting appliance 6 are possible. The lighting appliance 6 could be a lighting fixture 6 with a mounting for fixing the lighting fixture, for example, to a wall or ceiling. The lighting appliance 6 could be adapted to be placed on a horizontal surface, such as a shelf. The lighting appliance 6 may have a mounting with a clip or other device for temporarily or permanently gripping a post of other three dimensional object for support.

The lighting appliance 6 may have a housing, for example housing 27b, for the lighting source 25 and other components adapted to hide and to protect the internal components of the lighting appliance 6. The housing may serve as the housing 27a for the control 1.

An example of such a housing 27b and lighting appliance 6 is the lighting mount and lighting fixture described in co-pending U.S. patent application filed on the same date as this application under title Lighting Fixture And Lighting Mount by at least one of the applicants hereof, serial number not yet known. The content of the co-pending U.S. patent application is hereby incorporated by reference into the detailed description hereof.

It is known generally that features and functions can be performed in different programs on a controller 5 such that overall features and functions are equivalent. By describing specific embodiments with specific programmatic locations or flows for given features and functions it is not intended thereby to limit the overall scope of the invention, and its flexibility of implementation.

It will be understood by those skilled in the art that this description is made with reference to the preferred embodiment and that it is possible to make other embodiments employing the principles of the invention which fall within its spirit and scope as defined by the following claims.

We claim:

1. A lighting control for use with a lighting appliance, the lighting control comprising: a light sensor and a controller connected to the light sensor wherein the controller is adapted to activate the appliance when ambient light incident on the light sensor is greater than a threshold stored in the controller.

2. The lighting control of claim 1 wherein the controller is adapted to activate the appliance when ambient light incident on the sensor is greater than a threshold amount indicative of an interior of a closet of a room with a door of the closet open to the room and light available in the room.

3. The lighting control of claim 1 wherein the threshold is greater than a value indicative of the ambient conditions when a user is not intending to use an area in which the appliance is located.

4. The lighting control of claim 1 wherein the threshold is lower than a value indicative of sufficient ambient light in the closet for a person to work by.

5. The lighting control of claim 1 wherein the threshold is lower than a value indicative of sufficient ambient light in an area in which the appliance is located for a person to work by.

6. The lighting control of claim 1 wherein the controller is adapted to deactivate the lighting appliance once a given amount of time has passed since the lighting appliance was powered on.

7. A lighting combination for use in association with a power supply, the lighting combination comprising:
a. a lighting appliance including a lighting source powered by the power supply, and
b. the lighting control of claim 1 wherein the control is adapted to control activation of the lighting source.

8. The combination of claim 7 wherein the lighting control is adapted to be connected between the power supply and the lighting source, and wherein the lighting control is adapted to control activation of the lighting source by controlling the application of power to the lighting source through the lighting control.

9. The combination of claim 7 wherein the lighting control is adapted to be connected to the power supply, and wherein the lighting control is adapted to control activation of the lighting source by controlling the power supply to provide power to the lighting source.

10. The combination of claim 7 wherein the lighting control is adapted to be connected to the lighting source, and wherein the lighting control is adapted to control activation of the lighting source by controlling the power drawn by the lighting source from the power supply.

11. The combination of claim 7 wherein the power supply provides a DC supply of power, and the lighting control and lighting source are adapted to operate from DC power.

12. The combination of claim 11 wherein the lighting appliance comprises the power supply and the power supply includes a DC battery power source.

13. The combination of claim 12 wherein the battery power source is a non-rechargeable dry cell battery.

14. The combination of claim 11 wherein the lighting appliance comprises a power supply that is adapted to be connected to a power source external to the appliance for supply of power to the power supply.

15. The combination of claim 14 wherein the external power source is a non-rechargeable dry cell battery.

16. The combination of claim 14 wherein the external power source is an AC line source

17. The combination of claim 7 wherein the lighting appliance comprises the lighting control.

18. The combination of claim 17 wherein the lighting appliance comprises a housing and wherein the lighting control, the lighting source, and at least a portion of the power supply are housed by the housing.

19. The combination of claim 17 wherein the lighting appliance comprises a housing and wherein the lighting control, the lighting source, and the power supply are housed by the housing.

20. The combination of claim 7 wherein the lighting source comprises a series of light emitting diodes.

21. The control of claim 1 wherein the controller comprises a processor and associated memory for control of the controller.

22. The control of claim 21 wherein the controller is in the form of an integrated microcontroller that includes the processor and associated memory.

23. The control of claim 1 wherein the light sensor is a light dependent voltage divider.

24. The control of claim 23 wherein the divider comprises a light dependent resistor, the resistance of which varies according to the amount of light incident upon by the resistor.

25. The control of claim 24 wherein the voltage divider is adapted to output a voltage signal that varies as the light incident upon the light dependent resistor varies.

26. The control of claim 24 wherein the voltage divider is connected to the controller and the voltage signal is an input to the controller

27. The control of claim 26 wherein the control samples ambient light at the light sensor by having the controller read the signal input from the light sensor.

28. The combination of claim 19 wherein the power supply comprises a plurality of dry cell batteries and a voltage regulator, and wherein the plurality of dry cell batteries include a first terminal and a second terminal, the first terminal is connected to the lighting source and the second terminal is connected to a voltage regulator to provide a regulated power supply to drive the control.

29. The combination of claim 28 wherein the controller comprises an output and the lighting source is connected between the output of the controller and the first terminal of the battery such that the control can control power to the lighting source.

30. The combination of claim 29 wherein the output is a current sink output.

31. The control of claim 1 wherein the controller has integrated memory for storage of a program to control operation of the controller.

32. The control of claim 31 wherein the memory is programmed through an in system programming and serial programmable interface.

33. The control of claim 31 wherein the controller has a RESET input, and wherein activation of the RESET input causes the controller to restart the program.

34. The control of claim 33 wherein the RESET input is connected to a user-accessible switch external to the controller for activating the RESET input.

35. The control of claim 31 wherein the program comprises instructions to control the controller to control activation of the lighting source.

36. The control of claim 35 wherein the instructions comprise instructions to the controller to sample ambient light repeatedly at the light sensor, to check the samples to determine if the ambient light samples are greater than a threshold, represented by a value stored in memory, and if so, to activate the lighting source.

37. The control of claim 36 wherein the instructions further comprise instructions to the controller to check, after determining that the ambient light samples are greater than the threshold, to determine if the light samples are increasing in value over time, and if so, only then to activate the lighting source.

38. The control of claim 37 activating the lighting source by sinking current at an output of the controller such that current is drawn through the lighting source from the power supply.

39. The control of claim 37 wherein the instructions further comprise instructions to the controller to start an internal timer.

40. The control of claim 37 wherein the instructions further comprise instructions to call light off instructions.

41. The control of claim 37 wherein the instructions further comprise instructions to the controller to repeat repeatedly sampling and the instructions following repeatedly sampling if ambient light was not above the threshold or ambient light was not increasing.

42. The control of claim 39 wherein the instructions further comprise instructions to the controller to determine if the timer has timed out, and if not, to repeat determining if the timer has timed out and the instructions that follow.

43. The control of claim 39 wherein the instructions further comprise instructions to the controller to repeat the sampling light repeatedly instruction and the instructions that follow.

44. The control of claim 1 wherein the controller is adapted to determine the threshold based on the actual level of ambient light ordinarily available at the light sensor immediately before a user would want the lighting source to be activated.

45. The control of claim 2 the controller is adapted to determine the threshold based on the level of ambient light in the closet when the closet door is closed.

46. The control of claim 31 wherein the program comprises instructions to the controller to sample ambient light repeatedly, to average the ambient light samples, and to store in memory the average ambient light sample value.

47. The control unit of claim 46 wherein the controller is adapted to ensure the lighting source is deactivated before sampling to determine a threshold starts.

48. The control of claim 47 wherein the program comprises instructions to the controller to delay to allow ambient light to reach a desired level before sampling to determine a threshold starts.

49. The control of claim 31 wherein the program comprises instructions to the controller to sample ambient light, and to store in memory a light sample value.

50. The control unit of claim 49 wherein the controller is adapted to ensure the lighting source is deactivated before sampling to determine a threshold starts.

51. The control of claim 50 wherein the program comprises instructions to the controller to delay to allow ambient light to reach a desired level before sampling to determine a threshold starts.

52. The control of claim 1 further comprising a switch for manually powering the lighting source off.

53. The combination of claim 7 wherein the lighting appliance is a lighting fixture with a mounting for fixing the lighting fixture to an external support.

54. A method of operating a lighting control including a light sensor and a controller for use in association with a lighting appliance, the method comprising:
a. the light sensor sensing ambient light incident upon the light sensor, and
b. the controller activating the appliance when the sensed ambient light is greater than a threshold stored in the controller.

55. The method of claim 54 wherein the threshold amount is indicative of an interior of a closet of a room with a door of the closet open to the room and light available in the room.

56. The method of claim 54 wherein the threshold is greater than a value indicative of the ambient light when a user is not intending to use an area in which the appliance is located.

57. The method of claim 54 wherein the threshold is lower than a value indicative of sufficient ambient light in the closet for a person to work by.

58. The method of claim 54 wherein the threshold is lower than a value indicative of sufficient ambient light in an area in which the appliance is located for a person to work by.

59. The method of claim 54 wherein the controller deactivates the lighting appliance once a given amount of time has passed since the lighting appliance was powered on.

60. The method of claim 54 wherein the lighting control controls activation of the lighting source by controlling the application of power to the lighting source through the lighting control.

61. The method of claim 54 wherein the lighting control controls activation of the lighting source by controlling the power supply to provide power to the lighting source.

62. The method of claim 54 wherein the lighting control controls activation of the lighting source by controlling the power drawn by the lighting source from the power supply.

63. The method of claim 54 wherein the power supply provides a DC supply of power, and the lighting control and lighting source operates from DC power.

64. The method of claim 54 wherein the controller samples ambient light repeatedly at the light sensor, checks the samples to determine if the ambient light samples are greater than the threshold, represented by the value stored in memory, and if so, activates the lighting source.

65. The method of claim 64 wherein the controller checks, after determining that the ambient light samples are greater than the threshold, to determine if the light samples are increasing in value over time, and if so, only then activates the lighting source.

66. The method of claim 65 wherein the controller activates the lighting source by sinking current at an output of the controller such that current is drawn through the lighting source from a power supply.

67. The method of claim 65 wherein the controller starts an internal timer after activating the lighting source.

68. The method of claim 65 wherein controller repeats repeatedly sampling and the steps of the method following repeatedly sampling if ambient light was not above the threshold or ambient light was not increasing.

69. The method of claim 68 wherein the controller determines if the timer has timed out, and if not, repeats determining if the timer has timed out and the steps of the method that follow.

70. The method of claim 69 wherein after the timer has timed out the controller repeats the sampling light repeatedly instruction and the steps of the method that follow.

71. The method of claim 54 wherein, before the control unit senses ambient light to determine if the sensed ambient light is greater than the threshold, the controller determines the threshold based on the actual level of ambient light ordinarily available at the light sensor immediately before a user would want the lighting source to be activated.

72. The method of claim 55 wherein, before the control unit senses ambient light to determine if the sensed ambient light is greater than the threshold, the controller determines the threshold based on the level of ambient light in the closet when the closet door is closed.

73. The method of claim 54 wherein, before the control unit senses ambient light to determine if the sensed ambient light is greater than the threshold, the controller samples ambient light repeatedly, averages the ambient light samples, and stores in memory the average ambient light sample value as the threshold.

74. The method of claim 73 wherein the controller ensures the lighting source is deactivated before sampling to determine a threshold starts.

75. The method of claim 74 wherein the controller delays to allow ambient light to reach a desired level before sampling to determine a threshold starts.

76. The method of claim 54 wherein the controller samples ambient light, and stores in memory a light sample value as the threshold.

77. The method of claim 76 wherein the controller ensures the lighting source is deactivated before sampling to determine a threshold starts.

78. The method of claim 77 wherein the controller delays to allow ambient light to reach a desired level before sampling to determine a threshold starts.
